(19) United States
(12) Patent Application Publication
(10) Pub. No.: US 2010/0253156 A1
(43) Pub. Date: Oct. 7, 2010

(54) SENSOR DEVICE POWERED THROUGH RF HARVESTING

(76) Inventors: Jeffrey Iott, Monroe, MI (US); Thomas Alan Barnett, Ypsilanti, MI (US)

Correspondence Address: Carlson, Gaskey & Olds/Masco Corporation, 400 West Maple Road, Suite 350, Birmingham, MI, 48009, US

(21) Appl. No.: 12/419,449

(22) Filed: Apr. 7, 2009

(51) Int. Cl. H02J 17/00

(52) U.S. Cl. 307/149

(57) ABSTRACT

An example sensor device for a wireless system includes a receiver, an energy harvester and a transmitter. The receiver receives a signal and the energy harvester converts the signal into useable energy. The transmitter utilizes the useable energy to actuate a load.

### BACKGROUND OF THE DISCLOSURE

This disclosure relates generally to a sensor device, and more particularly to a sensor device constantly powered through radio frequency (RF) harvesting that is capable of transmitting a data string.

Sensor devices are known that wirelessly communicate with and that actuate electrically powered devices. For example, wireless light switches control a light fixture without the need for a hardwired electrical connection between the light fixture and the light switch. The wireless light switch wirelessly communicates with a receiver connected to the light fixture to turn the light fixture on and off.

Sensor devices of this type are typically powered by a source of energy that is only available for a limited amount of time. For example, many sensor devices include a transmitter embedded within the sensor device that converts mechanical energy into electricity to power a transmission from the sensor device to the receiver. The source of energy is supplied by a user's contact with the sensor device, such as contact by a user's finger. Because this source of energy is available for only a limited period of time, there is generally an insufficient amount of energy available to power various other features of the sensor device, such as on/off status, dimming level, silent switch and nightlight features.

Other known sensor devices are powered through mechanical, optical, battery, or hardwired energy sources. Access to these power sources is often limited in many sensor device applications. For instance, the sensor device may be recessed into a wall and require considerable labor to disassemble, or may be in an elevated location that is out of easy reach.

### SUMMARY OF THE DISCLOSURE

An example sensor device for a wireless system includes a receiver, an energy harvester and a transmitter. The receiver receives a signal and the energy harvester converts the signal into useable energy. The transmitter utilizes the useable energy to selectively actuate a load.

An example wireless system includes a building structure. A transmitter is located within the building structure. The wireless system also includes a sensor device that communicates with the transmitter. The sensor device is constantly powered by a signal received from the transmitter. An electrically powered device is selectively actuated by the sensor device.

An example method for use with a wireless system having at least one sensor device includes constantly powering the sensor device by a signal received external from the sensor device.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an example wireless system of a building structure;

FIG. 2 illustrates an example sensor device for use within the wireless system of FIG. 1;

FIG. 3 illustrates one example implementation of the wireless system of FIG. 1;

FIG. 4 illustrates various additional features of a sensor device of the wireless system depicted in FIG. 3;

FIG. 5 illustrates another example implementation of the wireless system of FIG. 1.

### DETAILED DESCRIPTION OF THE PREFERRED EMBODIMENT

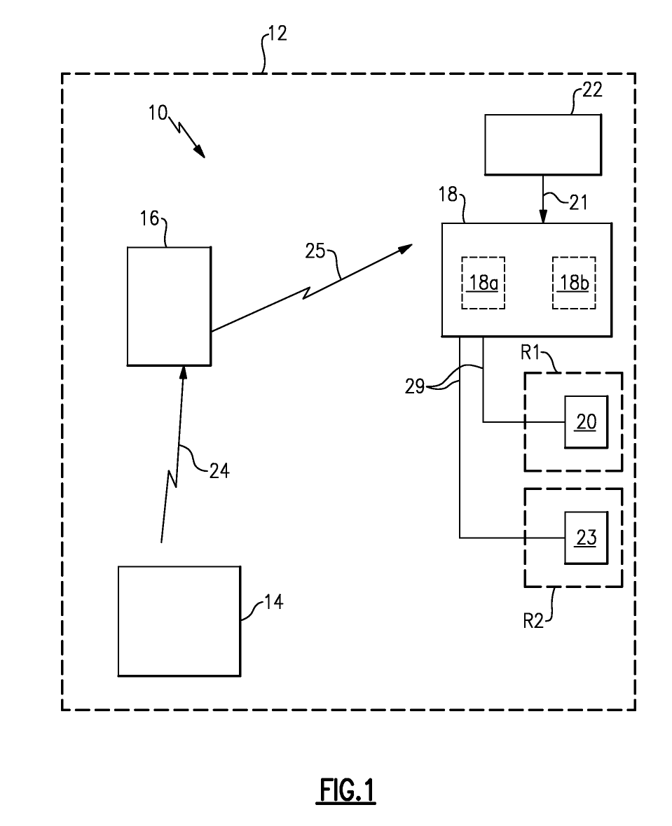

FIG. 1 illustrates a wireless system 10 of a building structure 12. The wireless system 10 depicted is not limited to any particular building structure 12 type and may include residential buildings, commercial buildings and the like. The wireless system 10 is also not limited to any particular type of system. Non-limiting examples of implementations of the wireless system 10 include lighting systems, thermostats, sensor systems, security systems and the like. As illustrated by the following non-limiting examples, the wireless system 10 can be utilized in a variety of different ways to communicate with a load through radio frequency (RF) harvesting.

The example wireless system 10 includes a dedicated source transmitter 14, a sensor device 16, a receiver 18 and an electrically powered device 20. In the illustrated example, a power supply 22 is in selective electrical communication with the electrically powered device 20, as indicated generally by the connecting line 21. The receiver 18 is electrically connected between the power supply 22 and the electrically powered device 20, as indicated generally by the connecting lines 29. For example, the receiver 18 is capable of selectively electrically connecting the electrically powered device 20 to the power supply 22. The receiver 18 may include hardware, software or both for serving this function. Although the receiver 18 is depicted as being a separate component from the electrically connected device 20, the various features and advantage of this disclosure are applicable to actuate an electrically powered device 20 that includes an integrated (i.e., built-in) receiver.

The receiver 18 is a single channel receiver for controlling operation of electrically powered device 20, in one example. In another example, the receiver 18 is a multichannel receiver capable of controlling operation of one or more additional electrically powered devices, such as additional electrically powered device 23. As an example, the receiver 18 may be Verve Living Systems product number X2110. The electrically powered devices 20, 23 can be located in separate rooms (or separate buildings) R1, R2, respectively, and could have different function. For example, the electrically powered device 20 could be a lighting device while the electrically powered device 23 could be fan.

In some examples, the receiver 18 of the wireless system 10 may also include additional components that enhance the operation of the wireless system 10. For instance, the receiver 18 may include a software module 18a and/or a memory module 18b. The software module 18a may facilitate analyzing signals received into the receiver 18 from one or more sensor devices 16. In examples where there are several sensor devices 16, the software module 18a identifies a received signal associated with a particular one of the sensor devices 16 (e.g., from a coded signal) and creates a desired output response. For instance, in response to a signal from one sensor device 16, the software module 18a may determine that the electrically powered device 20 should be activated, and in response to a signal from another one of the sensor devices 16, the software module 18a may determine that the electrically powered device 23 should be activated. Therefore, the software module 18a allows the receiver 18 to manage multiple sensor devices 16 and multiple different electrically powered device outputs.

The dedicated source transmitter 14 is positioned at any location within the building structure 12. The dedicated source transmitter 14 is a transmitter that is positioned at a strategic location within the building structure and is specifically tuned to a dedicated frequency for communicating with one or more sensor devices 16. As an example, the dedicated source transmitter 14 is a Powercast transmitter. As another example, the dedicated source transmitter 14 is a Ytricity transmitter. Although the example wireless system 10 is depicted with a single dedicated source transmitter 14, it should be understood that multiple dedicated source transmitters 14 could be positioned throughout the building structure 12.

A person of ordinary skill in the art having the benefit of this disclosure would be able to strategically locate the dedicated source transmitter 14 within the building structure 12 for constantly supplying power to the sensor device 16. The dedicated source transmitter 14 constantly communicates a signal 24 to the sensor device 16, such as a signal that includes RF energy. That is, the dedicated source transmitter 14 is capable of transmitting a data string. However, the wireless system 10 is not limited to any particular type of signal.

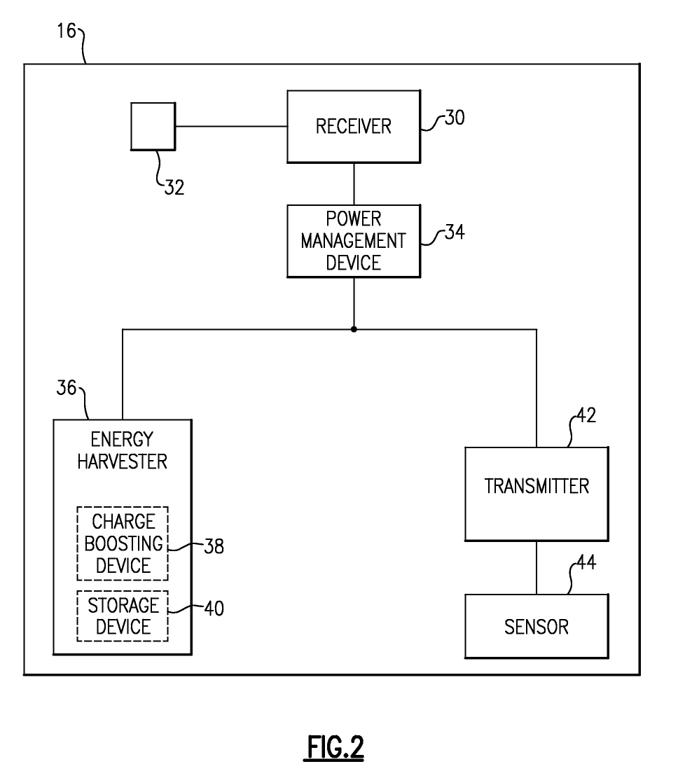

The sensor device 16 harvests the energy received from the dedicated source transmitter 14 and stores the energy for powering itself. The sensor device 16 includes the necessary hardware, software or both for serving this function, as is further discussed below with respect to FIG. 2.

The sensor device 16 utilizes the stored, useable energy to selectively wirelessly communicate with the receiver 18 to control the functionality of the electrically powered device 20. For example, the sensor device 16 communicates a signal 25, such as an RF signal, to the receiver 18 in response to a change of state action, such as manipulation of the sensor device 16. Other prompts may also trigger communication of the signal 25 from the sensor device 16 to the receiver 18. Once the receiver 18 receives the RF signal from the sensor device 16, the receiver 18 actuates the electrically powered device 20, such as by turning on a light, for example.

Although FIG. 1 depicts all of the electrically powered devices 20, 23 as being located within the same building structure 12, it should be understood that R1 and R2 could represent separate buildings, and that electrically powered devices 20, 23 could be located outside of the building structure 12 and still be actuated by the communication of the RF signal from the sensor device 16, so long as such electrically powered devices 20, 23 are within the RF frequency range of the sensor device 16.

FIG. 2, with continued reference to FIG. 1, illustrates an example sensor device 16 for use within the wireless system 10 described above. The sensor device 16 includes a receiver 30 having an antenna 32 that receives the signal 24 from the dedicated source transmitter 14. The antenna 32 is specifically tuned to match the frequency that is emitted by the dedicated source transmitter 14. A person of ordinary skill in the art would be able to select an appropriate antenna for use within the sensor device 16, including but not limited to, wire antennas, nano-doped plastic antennas and the like. A power management device 34 of the sensor device 16 manages the energy received by the receiver 30, stores the energy, and transmits a signal to power an electrically powered device 20.

The example sensor device 16 further includes an energy harvester 36. The energy harvester 36 includes a charge boosting device 38 and an energy storage device 40. The charge boosting device 38 converts the RF energy received from the transmitter 14 into useable energy. For example, the charge boosting device 38 increases the voltage of the received RF energy to convert the energy to useable energy. The useable energy is then stored within the energy storage device 40. In one example, the energy storage device 40 is a low leakage capacitor. However, other storage devices are contemplated as within the scope of this disclosure. The energy stored within the energy storage device 40 is available for use at all times by the sensor device 16. For example, the sensor device 16 is ready to communicate the signal 25 to the receiver 18 in response to any prompt. The sensor device 16 is continuously powered via the RF energy received from the dedicated source transmitter 14. That is, the sensor device 16 is continuously powered by harvesting RF energy from the dedicated source transmitter 14 positioned within the building structure 12.

A transmitter 42 of the sensor device 16 communicates with the receiver 18 of the wireless system 10 to actuate the electrically powered device 20. In this regard, the sensor device 16 may include hardware (e.g., timing circuits, logic circuits, a micro-processor, etc.), software, or both in addition to the transmitter 42 to provide a desired type of signal, such as a coded signal that identifies the particular sensor device 16, or providing “smart” capability that monitors the amount of power harvested and/or controls powering of the transmitter 42 and the sensor device 16.

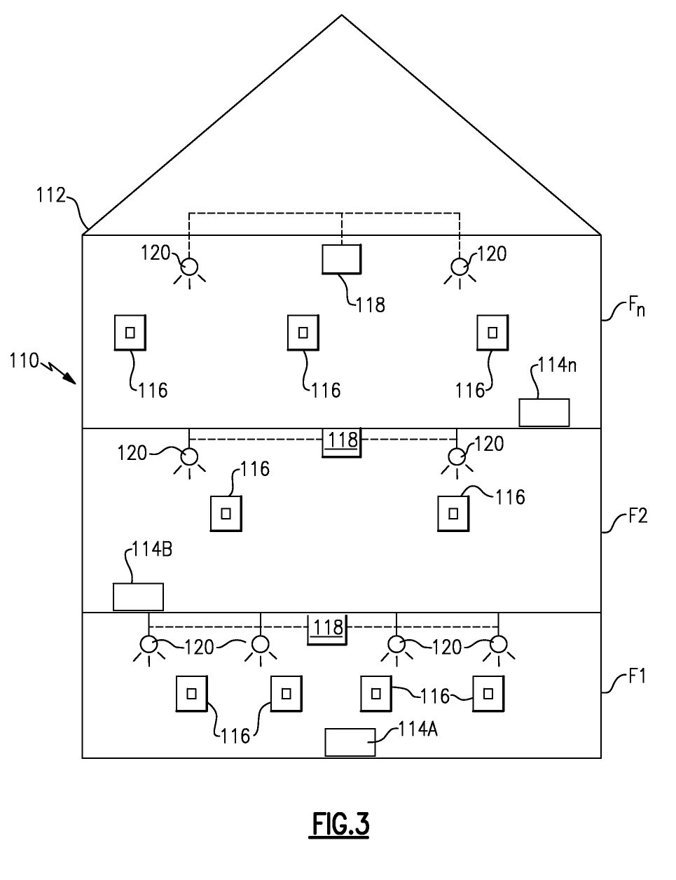

In the illustrated example, the sensor device 16 further includes a sensor 44 for detecting a position of an element of the sensor device 16, or for detecting a change of state of the sensor device 16. For example, where the wireless system 110 is a lighting system (See FIG. 3), the sensor 44 detects a positioning of a light switch. In this way, the sensor device 16 is capable of silent operation, such as through the use of a magnet and reed switch or hall-effect sensor, for example.

FIG. 3 illustrates one example implementation of the wireless system 10. In this example, the wireless system is a building control system such as a lighting system 110 that is somewhat similar to the wireless system 10 described in FIG. 1. In this disclosure, like reference numerals designate like elements where appropriate, and reference numerals with the addition of 100 or multiples thereof designate modified elements. It is to be understood that the modified elements incorporate the same features and benefits of the corresponding original elements, except where stated otherwise.

In this illustrated example, the lighting system 110 is positioned within a building structure 112 having a plurality of floors Fₙ. A dedicated source transmitter 114A is positioned on a first floor F1, another dedicated source transmitter 114B is positioned on a second floor F2, and a dedicated source transmitter 114ₙ is positioned on the Nth floor Fₙ. That is, in this example, one source transmitter 114 is positioned on each floor of the building structure 112. A person of ordinary skill in the art having the benefit of this disclosure would understand that additional dedicated source transmitters 114 may be positioned throughout the building structure 112. The actual positioning of each dedicated source transmitter 114 within the building structure 112 will vary depending upon design specific parameters including, but not limited to, the size and overall lighting requirements of the building structure 112.

Each floor F1, F2 and Fₙ includes a plurality of sensor devices 116 that are continuously powered by the energy harvested from the dedicated source transmitters 114A, 114B and 114ₙ. In one example, the sensor devices 116 represent wireless light switches. The sensor devices 116 utilize the energy received from the dedicated source transmitters 114A, 114B and 114ₙ to actuate a plurality of lighting fixtures 120 positioned throughout the building structure 112. The receivers 118 communicate wirelessly with the sensor devices 116 to control power to the lighting fixtures 120.

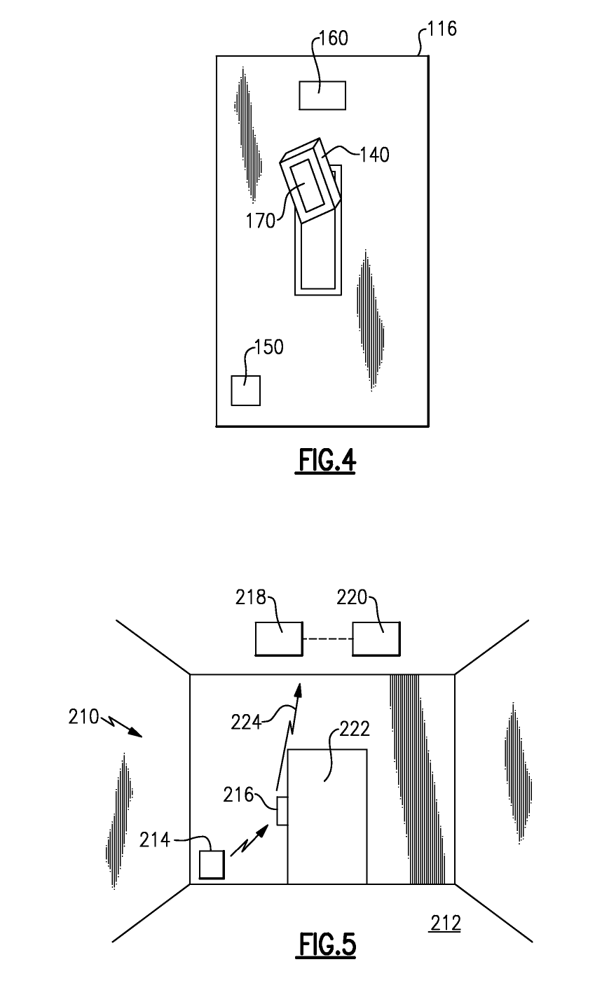

FIG. 4 illustrates additional features of the sensor devices 116 of the example wireless lighting system 110. In this example, the sensor device 116 is a light switch 140. Additional features could include, but are not limited to, on/off status indicator 150, dimming level indicator 160, integrated nightlight 170 and the like. Sufficient power is readily available within the sensor devices 116 to power these and any other additional features because the sensor devices 116 are constantly powered via harvesting the RF energy emitted by the dedicated source transmitters 114.

FIG. 5 illustrates another example implementation of the wireless system 10. In this example, the wireless system is a building control system such as a security system 210 that is somewhat similar to the wireless system 10. The security system 210 is associated with a building structure 212. In this regard, the security system 210 may be used in a variety of different ways to monitor security within the building structure.

The example security system 210 includes a dedicated source transmitter 214 that constantly powers the sensor device 216 via RF harvesting. The sensor devices 216 utilize the energy received from the dedicated source transmitter 214 positioned within the building structure 212 to actuate a security device 220. A receiver 218 communicates with the sensor device 216 to actuate the security device 220.

For example, the sensor device 216 may be coupled to a portion 222 of the building structure 212, such as a window, door, drawer, cabinet, gate or other portion 222 that would benefit from security monitoring. In response to a prompt, such as a security event, the sensor device 216 emits a wireless signal 224 to the receiver 218 that triggers the security device 220 to provide the security response. In one example, the prompt is opening of the door, drawer, gate, window or other portion 222 of the building structure 212.

The type of security response provided is not limited to any particular type and may include, for example, visual indications, audible indications, communications, or even mechanical responses. A person of ordinary skill in the art would understand that the example security system 210 could include multiple dedicated source transmitters 214, sensor devices 216, receivers 218 and security devices 220 to provide security monitoring of the entire building structure 212. Although this disclosure depicts the wireless system 10 as a building control system such as a lighting system 110 and a security system 210, it should be understood that the wireless system 10 could also include a thermostat system, a moisture sensor system, an environmental control system and the like to extend the capabilities of a wireless, batteryless network infrastructure.

Although a combination of features is shown in the illustrated examples, not all of them need to be combined to realize the benefits of various embodiments of this disclosure. In other words, a system designed according to one embodiment of the disclosure will not necessarily include each feature shown in any one of the figures or all of the portions schematically shown in the figures. Moreover, selected features of one example embodiment may be combined with selected features of other example embodiment.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A sensor device for a wireless system, comprising:
a receiver that receives a signal;
an energy harvester that converts said signal into usable energy; and
a transmitter that utilizes said usable energy to selectively actuate a load.

2. The device as recited in claim 1, wherein said sensor device is continuously powered by a dedicated source transmitter located external from said sensor device.

3. The device as recited in claim 1, wherein said sensor device is a component of a lighting system.

4. The device as recited in claim 1, wherein said sensor device is a component of a security system.

5. The device as recited in claim 1, wherein said energy harvester includes a charge boosting device that converts said signal into said usable energy, and an energy storage device that stores said usable energy.

6. The device as recited in claim 1, wherein said receiver includes an antenna that receives said signal.

7. The device as recited in claim 1, wherein said signal includes radio frequency (RF) energy.

8. The device as recited in claim 1, wherein said transmitter transmits a data string to communicate with said load.

9. A wireless system, comprising:
a building structure;
a transmitter located within said building structure;
a sensor device in communication with said transmitter, wherein said sensor device is constantly powered by a signal received from said transmitter; and
an electrically powered device actuated by said sensor device.

10. The system as recited in claim 9, wherein said signal includes RF energy.

11. The system as recited in claim 9, comprising a receiver in wireless communication with said sensor device, and said receiver receives a second signal from said sensor device to actuate said electrically powered device.

12. The system as recited in claim 9, wherein said building structure includes a plurality of floors and said transmitter includes a plurality of transmitters, and each of said plurality of floors includes at least one of said plurality of transmitters.

13. The system as recited in claim 9, wherein said sensor device includes a plurality of sensor devices, and at least one of said plurality of sensor devices is positioned on each of said plurality of floors.

14. The system as recited in claim 9, wherein said electrically powered device includes a plurality of electrically powered devices, and at least one of said plurality of electrically powered devices are positioned on each of said plurality of floors.

15. A method for use with a wireless system having at least one sensor device, comprising the steps of:
a) constantly powering the at least one sensor device with a signal received external from the at least one sensor device.

16. The method as recited in claim 15, wherein the wireless system includes a dedicated source transmitter, and comprising the steps of:
b) positioning the dedicated source transmitter within a building structure; and
c) communicating a signal from the dedicated source transmitter to the at least one sensor device to constantly power the at least one sensor device.

17. The method as recited in claim 15, wherein the signal includes RF energy.

18. The method as recited in claim 15, comprising the step of:
b) converting the signal received by at least one sensor device into useable energy.

19. The method as recited in claim 18, comprising the step of:
c) storing the usable energy within the at least one sensor device.

20. The method as recited in claim 18, wherein the wireless system includes a receiver and an electrically powered device in electrical communication with the receiver, and comprising the steps of:
c) utilizing the useable energy to communicate a signal to the receiver; and
d) actuating the electrically powered device in response to receiving the signal from the at least one sensor device.
